(19) United States
(12) Patent Application Publication
(10) Pub. No.: US 2002/0189668 A1
(43) Pub. Date: Dec. 19, 2002

(54) System and method for cracking hydrocarbons to reduce viscosity of crude oil for improved pumping

(75) Inventor: Leonard L. Manson, Scottsdale, AZ (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: WOODCOCK WASHBURN LLP, Philadelphia, PA (US)

(21) Appl. No.: 10/218,015

(22) Filed: Aug. 12, 2002

Related U.S. Application Data
(63) Continuation of application No. 09/299,065, filed on Apr. 23, 1999, now abandoned.

(51) Int. Cl. F17D 1/16; C10G 15/08; B01J 19/08

(52) U.S. Cl. 137/13; 208/370; 208/106; 204/168; 137/803; 422/186.21

(57) ABSTRACT

A method and apparatus for facilitating the pumping of crude oil through a pipe is disclosed. The facilitation includes receiving the crude oil through an input end of the pipe, processing the crude oil within the pipe to lower viscosity by at least partially cracking the crude oil into lower fractions and providing processed crude oil at the output end of the pipe in a reduced viscosity form. The step of processing the crude oil includes establishing an electrical discharge in proximity to the input end and passing the crude oil sufficiently close to the electrical discharge such that at least a portion is subjected thereto.

### FIELD OF THE INVENTION

The invention relates generally to methods and apparatus for pumping crude oil through piping and, more particularly, to methods and apparatus for reducing the viscosity of crude oil.

### BACKGROUND OF THE INVENTION

One of the important engineering tasks facing the oil industry is determining how to move crude oil from the well to a distant location. Typically crude oil is pumped from the ground through a network of pipes to refineries or distribution centers. Due to the relatively high viscosity of crude oil, pumping and transportation are not easy tasks. Indeed, such efforts are quite costly.

When pumping oil from wells, cost often becomes preclusive of further yield, i.e., the cost to pump and transport the crude oil becomes higher than the value of the crude oil. Although a given oil well may start with significant down hole pressure which helps to pump or move the crude oil, over time such pressure decreases. As the well loses down hole pressure the cost associated with moving the crude oil increases.

Moreover, once the crude oil has been removed from the well, transporting the product through piping to other locations, often miles away, also bears a high cost. Again, a major component of such transportation cost is associated with the pumping of the high viscosity crude oil. Such pumping costs become extremely significant when large pipe networks are utilized. Examples of large pipe networks include the “Alaskan Pipeline” and the many miles of transport pipelines located under the ocean.

### BRIEF DESCRIPTION OF THE DRAWINGS

The present invention will be better understood, and its numerous objects and advantages will become apparent to those skilled in the art by reference to the following detailed description of the invention when taken in conjunction with the following drawings, in which:

FIG. 1 is a partial sectional, partial diagrammatic view of a system for reducing the viscosity of crude oil, during transportation in a pipe, which system is constructed in accordance with the present invention; and

FIG. 2 is a section view of a section of pipe including apparatus for reducing the viscosity of crude oil constructed in accordance with the present invention.

### SUMMARY OF THE INVENTION

The present invention generally involves reducing the viscosity of hydrocarbons, and more specifically involves at least partially decomposing or “cracking” crude oil in order to reduce viscosity by means of an apparatus designed to accommodate the restricted conditions of well and transport piping.

In accordance with the present invention there is provided a system for the reduction of crude oil viscosity in order to afford ease of pumping and movement through piping networks. The system is comprised of an alternating current (A.C.) power supply and a power converter connected to the power supply for converting the A.C. current to direct current (D.C.). A power storing apparatus is connected to the power converter for storing a D.C. charge obtained from the D.C. current. The stored D.C. charge is utilized to power an arc generating assembly, producing an arc into a volume of crude oil contained within a section of pipe. The arc is sufficient to minimally crack the crude oil into lower fractions, thus reducing crude oil viscosity, as may be encountered within a transport piping system. Such reduced viscosity provides benefits to both the number of and design of pumps necessary to transport the crude oil.

Further, in accordance with the present invention there is provided a device for reduction of crude oil viscosity in order to reduce pumping costs. The system generally includes a controller and a Viscosity Reduction Device (VRD), configured such that they can be positioned within various transport pipe designs. D.C. electrical power storage is disposed in the VRD for generating a charge of electrical power provided by direct current. A high voltage generator is provided for the purpose of producing an arc within the transport pipe. The magnitude of the arc produced is in relation to the site of the applied electrical power charge. The arc generating assembly is attached to the high voltage generator and is disposed within the oil transport pipe. Arcs produced by the generating assembly reduce the viscosity of the passing crude oil.

Except for the arc discharge assembly, the VRD components may be mounted separately from an oil pipe, wherein the power and controlling components are supplied within suitable enclosures and a power cable connects such components to the arc discharge assembly positioned within the pipe. The power and controlling components may also be enclosed within a cylindrical body mounted around the exterior of an oil transport pipe such that the power supplies, the high voltage generator, and the associated electronics are external but concentric to the oil transport pipe. Although the power and controlling components are external to the pipe, the arc discharge assembly is located and mounted within the oil transport pipe. Additionally, a section of oil pipe and VRD components, mounted either internally or externally, may be appropriately dimensioned such that the overall diameter of the combined oil pipe and VRD components is no larger than that of a preselected diameter. In this manner the combined oil pipe and some VRD components may be deployed down a well in order to facilitate lower viscosity and improved pumping.

### DETAILED DESCRIPTION

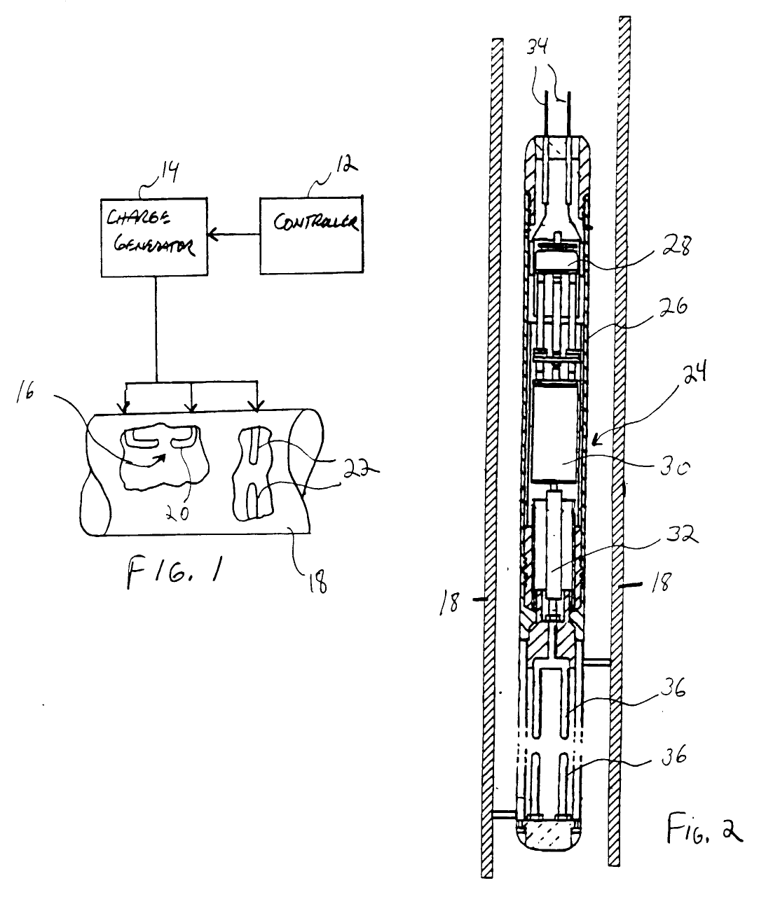

As shown in FIG. 1, the present invention includes three primary components, controller 12, charge generator 14 containing the electronic components necessary to drive electrode array assembly 16. This system partially cracks crude oil to reduce viscosity as an aid to pumping.

The circuitry of controller 12 is capable of controlling the amplitude and the duration of the arcs or shots emitted from electrode array assembly 16. The controller 12 generally operates from conventional A.C. power input of 240 volts, 30 amps, 50-60 Hz, provided by any conventional source of power. However, it is noted that the precise design of controller 12 and charge generator 14 can be of any design capable of generating an arc at electrode array assembly 16. The only requirements for controller 12 and charge generator 14 are that they be capable of generating an arc having a sufficient current value to crack crude oil passing in the vicinity of assembly 16.

In one preferred embodiment, charge generator 14 includes three replaceable modular sections (not shown). These sections include a power converter or charging unit, a capacitor bank and an arc generator assembly. The power converter changes the A.C. power supplied from controller 12 to D.C. power to be stored within a bank of capacitors.

The capacitor bank supplies a large amount of D.C. energy to an arc generating assembly, which generates an arc between electrodes at array 16. Arc array assembly 16 provides an arc field within the crude oil fluids in order to reduce viscosity of the crude oil in motion along transport pipe 18. The arc array assembly is comprised of electrode pairs distributed around the oil pipe axis over the area of the pipe's internal diameter. The electrodes may also be distributed along the pipe axis in order to act upon a greater volume of oil. Such electrode pairs may be oriented to generate an arc which is generally parallel to the flow of crude oil as in the case of electrodes 20 or may be oriented to generate an arc which is generally perpendicular to the flow of crude oil as in the case of electrodes 22.

In operation, a continuous series of arcs is discharged within the crude oil. This action disassociates the crude oil into lighter fractions, in turn reducing overall viscosity. Additionally, a light fraction of the oil is produced as a gas, the gas assisting by increasing pressure which aids the pumping process. Thus, it will be understood that pumping crude oil through a pipe, having an input end and an output end, can be made easier by receiving crude oil in the input end of the pipe, processing the crude oil to lower the viscosity by at least partially cracking the crude oil into lower fractions and providing processed crude oil at the output end in a reduced viscosity form.

The crude oil passes the arc array area only once and the oil must be sufficiently acted upon in order to substantially reduce overall oil viscosity. The arc array must be of sufficient effective area to afford sufficient disassociation of the crude oil volume as the oil passes through the arc array assembly. The discharge area comprises a diameter approximately that of the interior of the pipe. In addition to the diameter, the area also has an approximate overall length, effectively covering a solid cylindrical section of the pipe.

In an alternative embodiment, shown in FIG. 2, the charge generator is included in the entire body of VRD 24. VRD 24 is delivered to and positioned within oil pipe 18 at a location which will produce the most effect upon the oil. This location is normally as close to the oil's principle source as possible and is within oil pipe 18 in order to conserve physical space. VRD 24 has a body 26 that supports three replaceable modular sections. The sections are a power converter or charging unit 28, a capacitor bank 30 and an arc array assembly 32. Power converter 28 changes A.C. power from conductors 34 to D.C. power to be store within bank 30. Capacitor bank 30 is contained in and supported by the body of VRD 24 and includes a plurality of capacitors. These are conventional capacitors with a preferable capacity of 10 micro-farad, 5,000 volts D.C. Capacitor bank 30 supplies a large amount of energy to an electrode array of arc generating assembly 32, causing a strong electromagnetic wave within the crude oil. Arc array assembly 32 provides an arc field through the crude oil fluids in order to reduce viscosity of the crude oil in motion along the transport pipe. Arc array assembly 32 includes electrode pairs 36 distributed around the oil pipe axis over the area of the pipe's internal diameter. The electrodes may also be distributed along the pipe axis in order to act upon a greater volume of oil. Because the oil is processed “on the fly” and only once, the maximum conversion efficiency of the oil and viscosity reduction must be accomplished in a single pass. This efficiency is highly dependant upon the precise arrangement of the electrodes, the generated arc, and the repetition rate of the arc.

For purposes of explanation, a voltage of 5,000 volts is applied to electrode pair 36. It is noted that this energy may be any desired voltage depending on the particular application of the system. In the event that the system is employed within a larger pipe, such as the Alaskan pipe line, a larger number of electrode pairs may be required. To ensure the efficient reduction of oil viscosity the number of electrodes, the rate of arc production, and the rate of oil flow produced by pumping must be integrated. This is primarily because the arc production is repetitive rather than continuous. Any oil, passing the arc array area will be reduced in viscosity only when an arc is being produced. The viscosity reduction is effectively averaged over the length of pipe 18. The control console monitors the viscosity of the crude oil entering and exiting VRD 24, and controls the repetition rate of the arc, the pumping rate, and the energy delivered to the electrode array assembly. This provides the ability to optimize the conversion efficiency. If viscosity sensors are positioned on VRD 24, the signals from the viscosity sensors may be impressed upon the power cables and then extracted outside pipe 18 for processing.

While the invention has been described and illustrated with reference to specific embodiments, those skilled in the art will recognize that modification and variations may be made without departing from the principles of the invention as described herein above and set forth in the following claims.

The following is claimed:

1. A method for pumping crude oil through a pipe, the pipe having an input end and an output end, the method comprising the steps of:
receiving crude oil in the input end;
processing crude oil to lower viscosity by at least partially cracking the crude oil into lower fractions; and
providing processed crude oil at the output end in a reduced viscosity form.

2. The method of claim 1, wherein the step of processing the crude oil comprises the step of establishing an electrical discharge in proximity to the input end of the pipe and passing the crude oil sufficiently close to the electrical discharge such that at least a portion of the crude oil is subjected thereto.

3. The method of claim 2, wherein the step of establishing an electrical discharge comprises the steps of generating an electrical charge and positioning electrodes, connected to receive the electrical charge, within the pipe so that at least a portion of the crude oil passes sufficiently close to the electrodes.

4. Apparatus for facilitating pumping crude oil through a pipe, said apparatus comprising:
a charge generator, adapted for positioning within the pipe, for generating an electrical charge; and
electrodes, connected to the charge generator, for disseminating the electrical charge, the electrodes being adapted for positioning within the pipe so that at least a portion of the crude oil passes sufficiently close to the electrodes such that said at least portion is acted upon by the dissemination of the electrical charge.
